(19) United States
(12) Patent Application Publication
(10) Pub. No.: US 2004/0089705 A1
(43) Pub. Date: May 13, 2004

(54) Waterproof mechanism of key of handheld computer

(76) Inventor: Chien Shen Yuan, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/292,423

(22) Filed: Nov. 13, 2002

(51) Int. Cl. G06D 1/00; G06C 7/02; G06C 25/00

(52) U.S. Cl. 235/145 R

(57) ABSTRACT

A waterproof mechanism of key of a handheld computer includes a rubber outer cover, a sheet body, and a back glue. The sheet body is dispose in the rubber outer cover to prop up and fix the shape of the rubber outer cover. A soft key circuit board is disposed in the rubber outer cover and the sheet body. Circuits of the soft circuit board pass through the sheet body and the back glue. One face of the back glue adheres to the sheet body, and the other face thereof adheres to the inside of a key base. The rubber outer cover is compressed to deform and be hermetically fastened in the key base. Through tight connection of the rubber outer cover and the key base and adhesion of the back glue, water and liquid cannot permeate into the key base, hence achieving a very good waterproof effect.

### FIELD OF THE INVENTION

The present invention relates to a waterproof mechanism of key of a handheld computer and, more particularly, to a design of key of a handheld computer having a very good waterproof effect.

### BACKGROUND OF THE INVENTION

As shown in FIG. 1, in a conventional key design, a hard rubber outer cover 10A is directly fixed onto a key base 20A, and a waterproof film 15A is pasted on a key circuit board 21A in the key base 20A.

In the above key of a handheld computer, the hard rubber outer cover 10A is fastened onto the key base 20A, and a large gap exists around the hard rubber outer cover 10A and the key base 20A. Therefore, moisture and liquid will easily permeate into the key base 20A. Although the waterproof film 15A is pasted on the key circuit board 21A, one cannot say for sure the waterproof film 15A is tightly pasted and whether the waterproof film 15A will be eroded or crack after a longtime use. Moreover, once moisture or liquid permeate into the host body though the gap around the hard rubber outer cover 10A and the key base 20A, delicate circuits of the handheld computer will be seriously damaged.

Accordingly, the conventional key structure of a handheld computer has inconvenience and drawbacks in practical use. The present invention aims to resolve the problems in the prior art.

### SUMMARY OF THE INVENTION

The primary object of the present invention is to provide a waterproof mechanism of key of a handheld computer. Through tight connection of a rubber outer cover and a key base and adhesion of a back glue, water and liquid cannot permeate into the key base to affect circuit boards therein.

To achieve the above object, the present invention provides a waterproof mechanism of key of a handheld computer. The waterproof mechanism of key comprises a rubber outer cover, a sheet body, and a back glue. The rubber outer cover is made of soft rubber. The sheet body is stuffed in the rubber outer cover to prop up and fix the shape of the rubber outer cover. The rubber outer cover is compressed to deform and be hermetically fastened in a key base of the handheld computer. A soft key circuit board is disposed in the rubber outer cover and the sheet body. Circuits of the soft circuit board pass through the sheet body and the back glue. The back glue adheres to the sheet body to tightly fix the sheet body in the rubber outer cover.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of a conventional key structure;

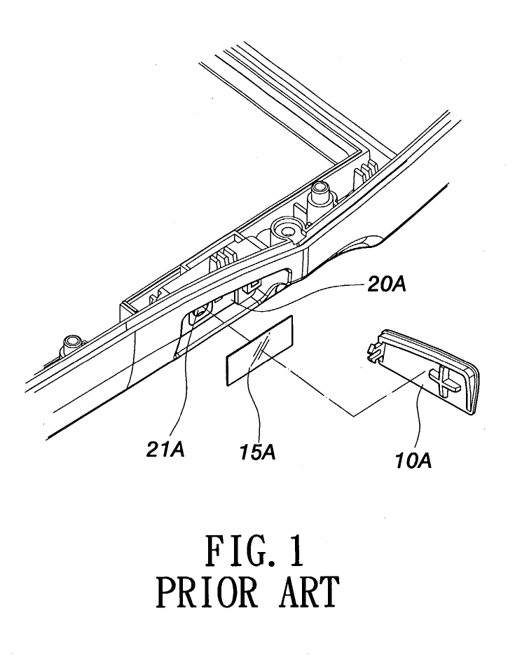

FIG. 2 is an exploded perspective view of the present invention;

FIG. 3 is a perspective view of the present invention; and

FIG. 4 is a cross-sectional view of the present invention.

### DETAILED DESCRIPTION OF THE PREFERRED EMBODIMENTS

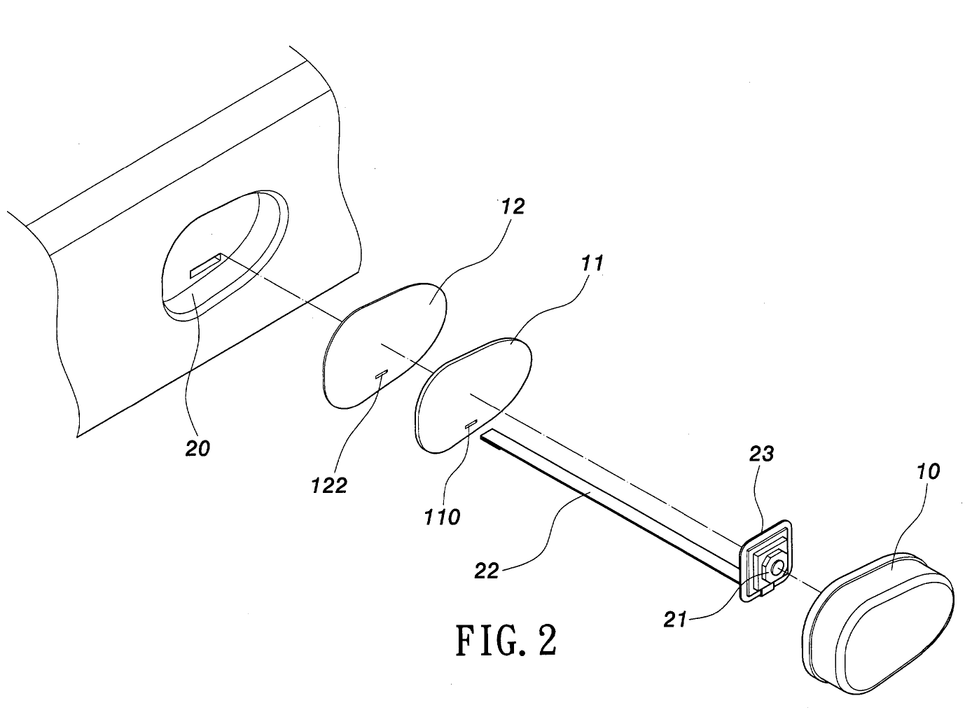

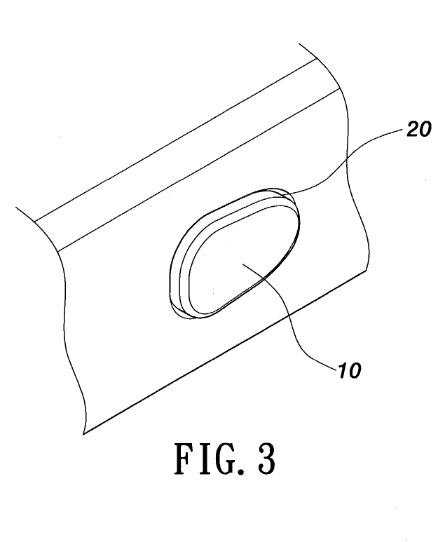

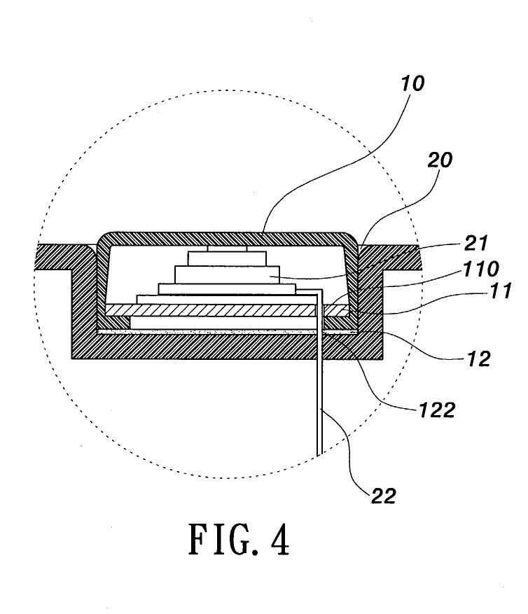

As shown in FIGS. 2 to 4, the present invention provides a waterproof mechanism of key of a handheld computer. The waterproof mechanism comprises a rubber outer cover 10, a sheet body 11, and a back glue 12. The rubber outer cover 10 is made of a soft rubber having a slight elasticity.

The sheet body 11 is a hard metal sheet with a size is the same as a key base 20 and having a linear slit 110 thereon. The sheet body 11 is disposed in the rubber outer cover 10. Through the hard metal sheet of the sheet body 11, the rubber outer cover 10 is propped up to fix its shape.

The back glue 12 is a double-faced glue with a thin slit 122 disposed thereon. A key circuit board 21 is disposed in the rubber outer cover 10 and the sheet body 11. A back glue layer 23 is disposed at the lower end of the key circuit board 21 to adhere to the sheet body 11. Circuits 22 of the key circuit board 21 pass through the linear slit 11 of the sheet body 11 and the slit 122 of the back glue 12. Stickiness of one face of the back glue 12 is utilized to fix the sheet body 11 in the rubber outer cover 10 and stickiness of the other face thereof is utilized to adhere to the sheet body 1 in the key base 10.

The sheet body 11 is stuffed in the soft rubber outer cover 10, which is then stuffed into the key base 20. The sheet body 11 and the key base 20 have the same size. Because of the thickness of the rubber outer cover 10 and slight elasticity of the rubber outer cover 10, when the rubber outer cover 10 is fastened, it will be compressed to deform and be hermetically fastened in the key base 20. The rubber outer cover 10 can thus be fixedly fastened in the key base 20 and slightly protrudes from the surface of a housing of the handheld computer. Therefore, external moisture and liquid cannot permeate into the key base 20. Moreover, because one face of the back glue 12 tightly adheres to the sheet body 11 and the other face thereof adheres to the inside of the key base 20, external or internal moisture and liquid cannot damage the key circuit board 21.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A waterproof mechanism of key of a handheld computer, comprising:
a rubber outer cover made of soft rubber being deformably hermetically fastened in a key base of said handheld computer;
a sheet body stuffed in said rubber outer cover to prop up and fix a shape of said rubber outer cover; and
a back glue for adhering to said sheet body to tightly fix said sheet body in said rubber outer cover.

2. The waterproof mechanism of key of a handheld computer as claimed in claim 1, wherein said rubber outer cover is made of soft rubber having a slight elasticity.

3. The waterproof mechanism of key of a handheld computer as claimed in claim 1, wherein said sheet body is a hard metal sheet.

4. The waterproof mechanism of key of a handheld computer as claimed in claim 1, wherein said sheet body and said key base are of the same size.

5. The waterproof mechanism of key of a handheld computer as claimed in claim 1, wherein said sheet body has a linear slit thereon.

6. The waterproof mechanism of key of a handheld computer as claimed in claim 1, wherein said back glue has a slit thereon.

7. The waterproof mechanism of key of a handheld computer as claimed in claim 1, wherein said back glue is a double-faced glue with one face adhering to said sheet body and the other face adhering to an inside of said key base.
